(19) United States
(12) Patent Application Publication
(10) Pub. No.: US 2026/0132935 A1
(43) Pub. Date: May 14, 2026

(54) MICROWAVE OVEN APPLIANCE AND FILTER ASSEMBLY THEREFOR

(71) Applicant: Haier US Appliance Solutions, Inc., Wilmington, DE (US)

(72) Inventors: Dong Soo Shin, Seoul (KR); Byung Cheon Lee, Seoul (KR)

(21) Appl. No.: 18/945,612

(22) Filed: Nov. 13, 2024

(51) Int. Cl. F24C 15/20; H05B 6/64

(52) U.S. Cl. CPC F24C 15/2042; F24C 15/2035; H05B 6/6426

(57) ABSTRACT

A microwave appliance includes a cabinet including a plurality of walls forming a cooking chamber. A cabinet opening is formed at a front wall of the plurality of walls. A door is positioned adjacent to the front wall when in a closed position. A deflector includes a front face contoured from a vent opening to a rear opening. The deflector includes a sidewall extending from the front face to form an airflow passage extending from the vent opening to the rear opening. A mount wall within the airflow passage forms a surface against which a filter assembly is disposable within the airflow passage.

### FIELD OF THE INVENTION

The present disclosure relates generally to microwave oven appliances. In particular, the disclosure relates to microwave oven appliances and filter assemblies therefor.

### BACKGROUND OF THE INVENTION

Built-in kitchen appliances, for example microwave ovens, have become commonplace in household kitchens. In many applications, a microwave is built-in over a cooktop or range. Microwaves configured in this arrangement are generally referred to as over-the-range (OTR) appliances. In many cases, OTR microwave ovens include a ventilation system to capture and redirect steam, smoke, airborne grease, or odors generated at the range.

OTR appliances are limited in the positioning of ancillary systems, such as lighting systems. For instance, lighting systems are challenged to avoid ventilation systems, such as to avoid obstruction of ventilation openings. Kitchen cabinets further limit positioning of a lighting system.

Accordingly, an OTR microwave and system addressing one or more of these issues would be beneficial and advantageous.

### BRIEF DESCRIPTION OF THE INVENTION

Aspects and advantages of the invention will be set forth in part in the following description, may be apparent from the description, or may be learned through practice of the invention.

An aspect of the present disclosure is directed to an over the range microwave appliance defining a vertical direction, a lateral direction, and a transverse direction. The over the range microwave appliance includes a cabinet including a plurality of walls forming a cooking chamber. A cabinet opening is formed at a front wall of the plurality of walls. A door is positioned adjacent to the front wall when in a closed position. A deflector includes a front face contoured from a vent opening to a rear opening. The deflector includes a sidewall extending from the front face to form an airflow passage extending from the vent opening to the rear opening. A mount wall within the airflow passage forms a surface against which a filter assembly is disposable within the airflow passage.

An aspect of the present disclosure is directed to a microwave appliance defining a vertical direction, a lateral direction, and a transverse direction. The microwave appliance includes a cabinet including a plurality of walls forming a cooking chamber. A cabinet opening is formed at a front wall of the plurality of walls. A door is positioned adjacent to the front wall when in a closed position. A deflector includes a front face contoured from a vent opening to a rear opening. The deflector includes a sidewall extending from the front face to form an airflow passage extending from the vent opening to the rear opening. A mount wall within the airflow passage forms a surface against which a filter assembly is disposable within the airflow passage.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a system, including a microwave oven appliance, in accordance with an embodiment of the present disclosure;

FIG. 2 provides a perspective view of a microwave oven appliance in accordance with an embodiment of the present disclosure;

FIG. 3 provides an exploded view of components of the microwave oven appliance in accordance with an embodiment of the present disclosure;

FIG. 4 provides a front perspective view of a deflector assembly of the microwave oven appliance in accordance with an embodiment of the present disclosure;

FIG. 5 provides a rear perspective view of the deflector assembly of the microwave oven appliance in accordance with an embodiment of the present disclosure;

FIG. 6 provides a rear perspective view of the deflector assembly of the microwave oven appliance, with filter assembly partially positioned, in accordance with an embodiment of the present disclosure;

FIG. 7 provides a rear perspective view of the deflector assembly of the microwave oven appliance, with filter assembly removed, in accordance with an embodiment of the present disclosure;

FIG. 8 provides a front perspective view of a deflector of the microwave oven appliance in accordance with an embodiment of the present disclosure;

FIG. 9 provides a front perspective view of the deflector of the microwave oven appliance, with filter assembly partially positioned, in accordance with an embodiment of the present disclosure;

FIG. 10 provides a perspective view of a filter assembly for the deflector in accordance with an embodiment of the present disclosure;

FIG. 11 provides a perspective view of a filter assembly for the deflector in accordance with an embodiment of the present disclosure;

FIG. 12 provides a detailed perspective view of a filter assembly for the deflector in accordance with an embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

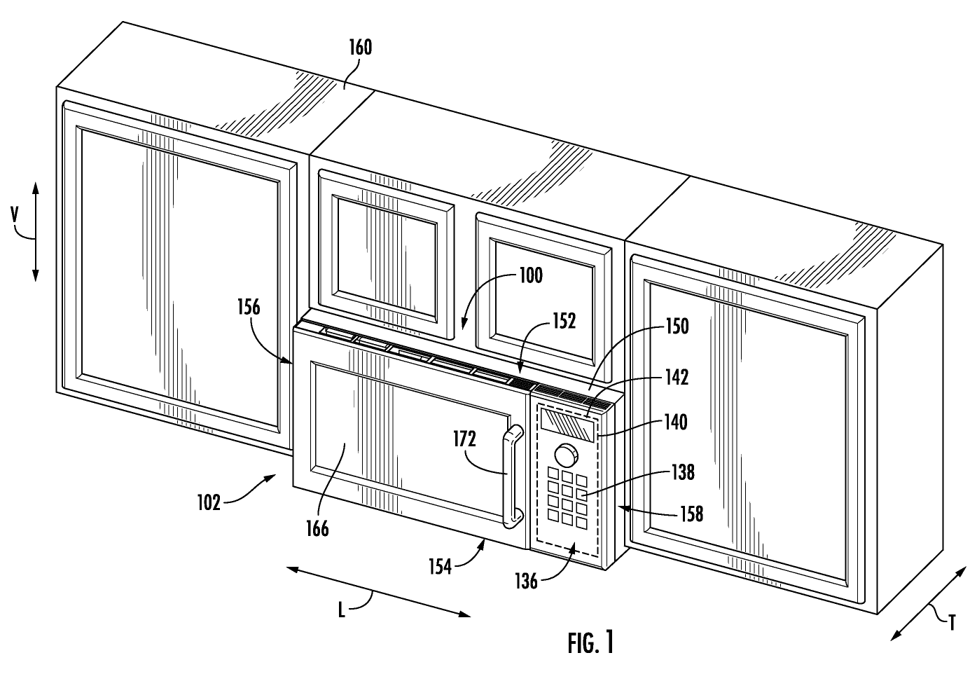

Turning to the figures, FIG. 1 provides a perspective view of a system 100 according to exemplary embodiments of the present disclosure. System 100 generally includes an over-the-range (OTR) microwave appliance 102 that can be positioned or mounted above a cooktop appliance or range. It should be appreciated that the present subject matter is not limited to the specific appliances disclosed, and the specific appliance configurations are not intended to limit the scope of the present subject matter in any manner. Reference to a microwave throughout this disclosure is for purposes of illustration and not to limit the scope of the disclosure.

As shown in FIG. 1, system 100 defines a vertical direction V, a lateral direction L, and a transverse direction T. The vertical, lateral, and transverse directions are mutually perpendicular and form an orthogonal direction system. As used herein, this coordinate system applies equally to both microwave appliance 102 and range 104 and will thus be used interchangeably to describe both appliances and their positions relative to each other.

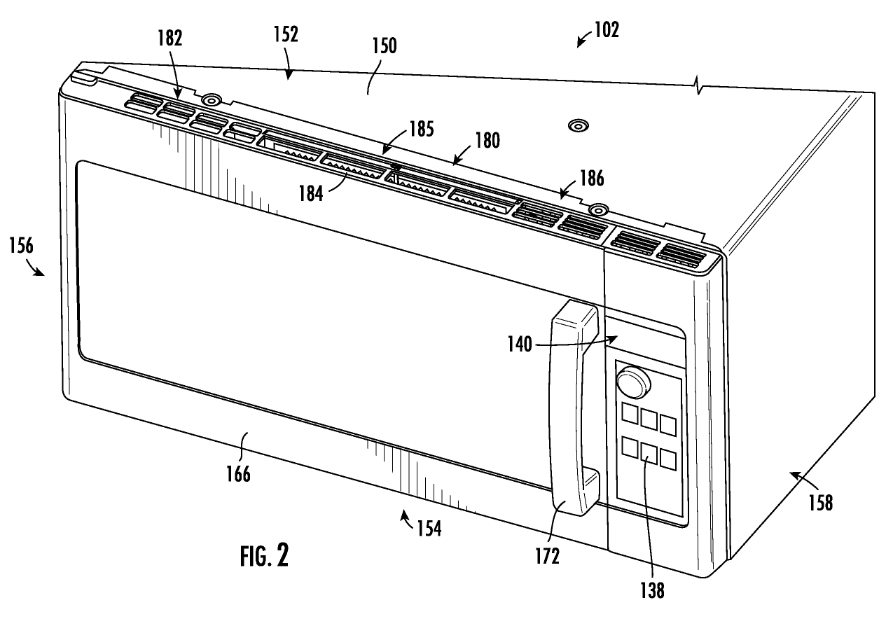

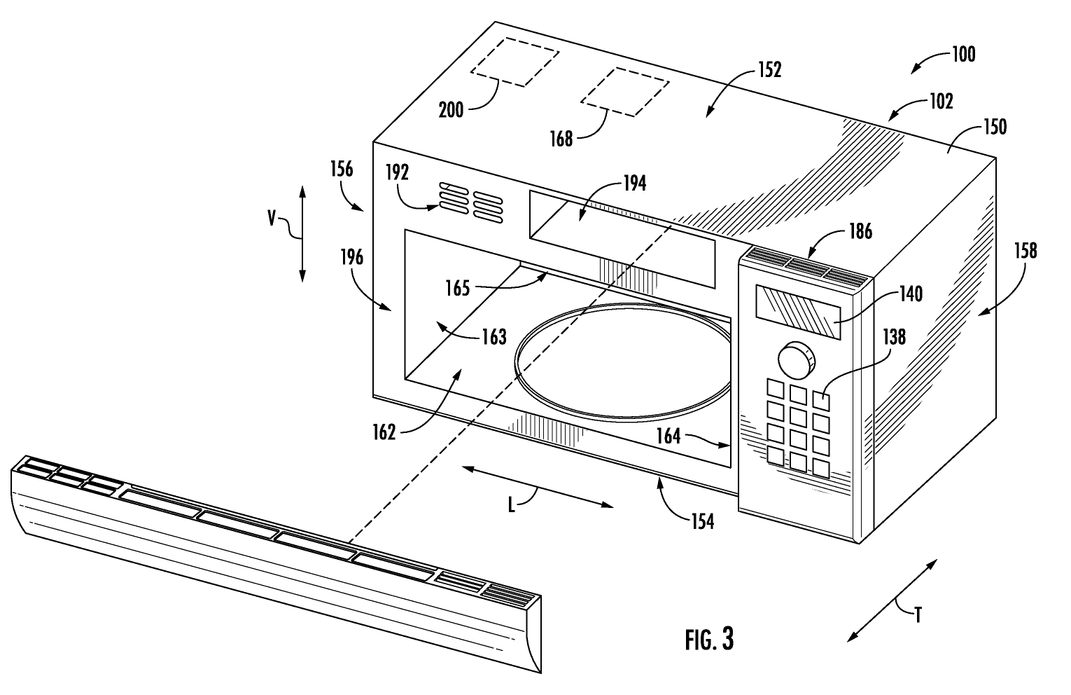

Referring still to FIG. 1, and furthermore to the perspective view in FIG. 2 and the exploded view in FIG. 3, microwave appliance 102 may include a control panel 136 that may represent a general-purpose Input/Output (“GPIO”) device or functional block for microwave appliance 102. In some embodiments, control panel 136 may include or be in operative communication with one or more user input devices 138, such as one or more of a variety of digital, analog, electrical, mechanical, or electro-mechanical input devices including rotary dials, control knobs, push buttons, toggle switches, selector switches, and touch pads. Additionally, microwave appliance 102 may include a display 140, such as a digital or analog display device generally configured to provide visual feedback regarding the operation of microwave appliance 102. For example, display 140 may be provided on control panel 136 and may include one or more status lights, screens, or visible indicators. According to exemplary embodiments, user input devices 138 and display 140 may be integrated into a single device, e.g., including one or more of a touchscreen interface, a capacitive touch panel, a liquid crystal display (LCD), a plasma display panel (PDP), a cathode ray tube (CRT) display, or other informational or interactive displays.

Microwave appliance 102 may further include or be in operative communication with a processing device or a controller 142 that may be generally configured to facilitate appliance operation. In this regard, control panel 136, user input devices 138, and display 140 may be in communication with controller 142 such that controller 142 may receive control inputs from user input devices 138, may display information using display 140, and may otherwise regulate operation of microwave appliance 102. For example, signals generated by controller 142 may operate microwave appliance 102, including any or all system components, subsystems, or interconnected devices, in response to the position of user input devices 138 and other control commands. Control panel 136 and other components of microwave appliance 102 may be in communication with controller 142 via, for example, one or more signal lines or shared communication busses. In this manner, Input/Output (“I/O”) signals may be routed between controller 142 and various operational components of microwave appliance 102.

As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 142 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 142 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 142 may be operable to execute programming instructions or micro-control code associated with an operating cycle of appliance 102. In this regard, the instructions may be software or any set of instructions that when executed by the processing device, cause the processing device to perform operations, such as running one or more software applications, displaying a user interface, receiving user input, processing user input, etc. Moreover, it should be noted that controller 142 as disclosed herein is capable of and may be operable to perform any methods, method steps, or portions of methods as disclosed herein. For example, in some embodiments, methods disclosed herein may be embodied in programming instructions stored in the memory and executed by controller 142.

The memory devices may also store data that can be retrieved, manipulated, created, or stored by the one or more processors or portions of controller 142. The data can include, for instance, data to facilitate performance of methods described herein. The data can be stored locally (e.g., on controller 142) in one or more databases and/or may be split up so that the data is stored in multiple locations. In addition, or alternatively, the one or more database(s) can be connected to controller 142 through any suitable network(s), such as through a high bandwidth local area network (LAN) or wide area network (WAN). In this regard, for example, controller 142 may further include a communication module or interface that may be used to communicate with one or more other component(s) of microwave appliance 102, controller 142, an external appliance controller, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

As noted above, microwave appliance 102 may be positioned or mounted above range 104 (e.g., as an over-the-range (OTR) microwave), such as depicted in FIG. 1. Specifically, a cabinet 150 of microwave appliance 102 may be positioned above range 104 along the vertical direction V.

In various embodiments, the cabinet 150 may be an insulated cabinet. As depicted in FIGS. 2-3, cabinet 150 of microwave appliance 102 includes a plurality of walls and when assembled, microwave appliance 102 generally extends along the vertical direction V between a top end 152 and a bottom end 154; along the lateral direction L between a first side end 156 and a second side end 158; and along the transverse direction T between a front end and a rear end.

A cooking chamber 162 is formed within cabinet 150. The cooking chamber 162 is formed between a first side wall 163 laterally spaced from a second side wall 164, and a rear wall 165 transversely spaced from a door 166. Microwave appliance 102 is generally configured to heat articles (e.g., food or beverages) within the cooking chamber 162 using electromagnetic radiation. Microwave appliance 102 may include various components which operate to produce the electromagnetic radiation, as is generally understood. For example, microwave appliance 102 may include a heating assembly 168 in a mechanical space 200, the heating assembly 168 having a magnetron (e.g., a cavity magnetron), a high voltage transformer, a high voltage capacitor, and a high voltage diode, as is understood. The transformer may provide energy from a suitable energy source (such as an electrical outlet) to the magnetron. The magnetron may convert the energy to electromagnetic radiation, specifically microwave radiation. The capacitor generally connects the magnetron and transformer, such as via high voltage diode, to a chassis. Microwave radiation produced by the magnetron may be transmitted through a waveguide to cooking chamber 162.

The structure and intended function of microwave oven are generally understood by those of ordinary skill in the art and are not described in further detail herein. Embodiments of the microwave appliance 102 provided herein may generally be positioned at, within, or mounted to a cooking area cabinet 160, such as a kitchen cupboard or other furnishing.

The door 166 is movably mounted (e.g., rotatably attached) to cabinet 150 in order to permit selective access to cooking chamber 162. Specifically, door 166 can move between an open position (not pictured) and a closed position (e.g., FIG. 1). The open position permits access to cooking chamber 162 while the closed position restricts access to cooking chamber 162. The handle 172 may be mounted to or formed on door 166 to assist a user with opening and closing door 166. When in a closed position, the door 166 abuts or is adjacent to a front wall 196 of the cabinet 150.

Referring back to FIG. 3, the cabinet 150 may form a plurality of openings. A first cabinet opening 192 may correspond to a humidity sensor air outlet. A second cabinet opening 194 may correspond to a vent hood recirculation air outlet. A third opening 186 may correspond to a cooling air inlet into the cabinet 150. In various embodiments, openings 192, 194 are formed at the front wall 196 of the cabinet 150.

A ventilation grille or deflector 180 forms openings corresponding, at least in part, to the plurality of openings at the cabinet 150, or at least a portion thereof. For instance, the deflector 180 may include a first deflector opening 182 corresponding to the first cabinet opening 192. The deflector 180 includes a second deflector opening or vent opening 184 corresponding to the second cabinet opening 194. The deflector 180 may include a third opening 186, such as corresponding to a cooling air inlet. However, as depicted in FIG. 3, the third opening 186 may be formed at the cabinet 150 or control panel housing at which user input devices 138 are positioned. Embodiments of the deflector 180 are configured to receive a filter assembly 210 and facilitate access, installation, and removal of the filter assembly 210 at the deflector 180.

In various embodiments, microwave appliance 102 is configured to receive air through opening 186 and exhaust from the cabinet 150 through opening 182, 184. For instance, air may circulate from outside of the cabinet 150 and into opening 186. A filter assembly, such as further described herein, is configured to remove smoke and odor from the air before exhausting from the cabinet 150 through an exhaust opening (e.g., opening 184).

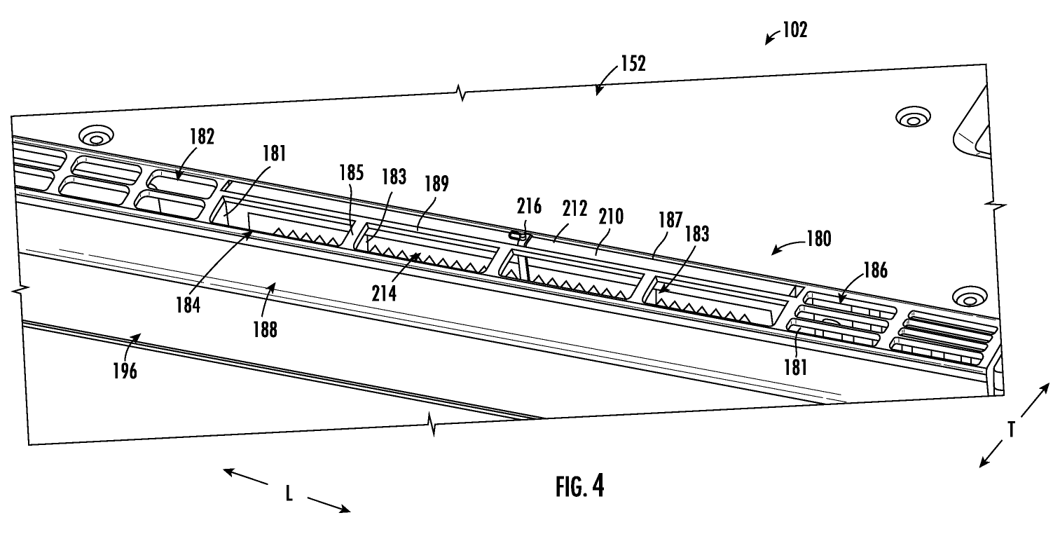

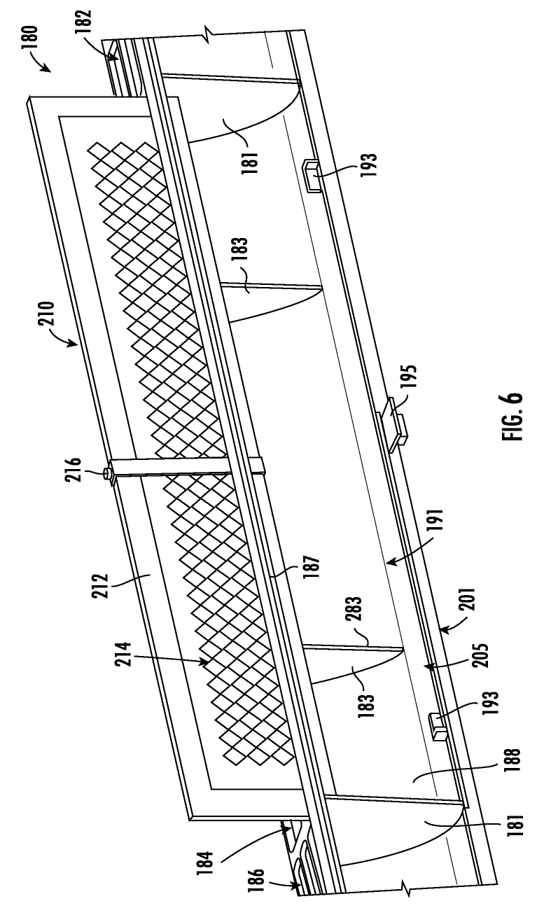

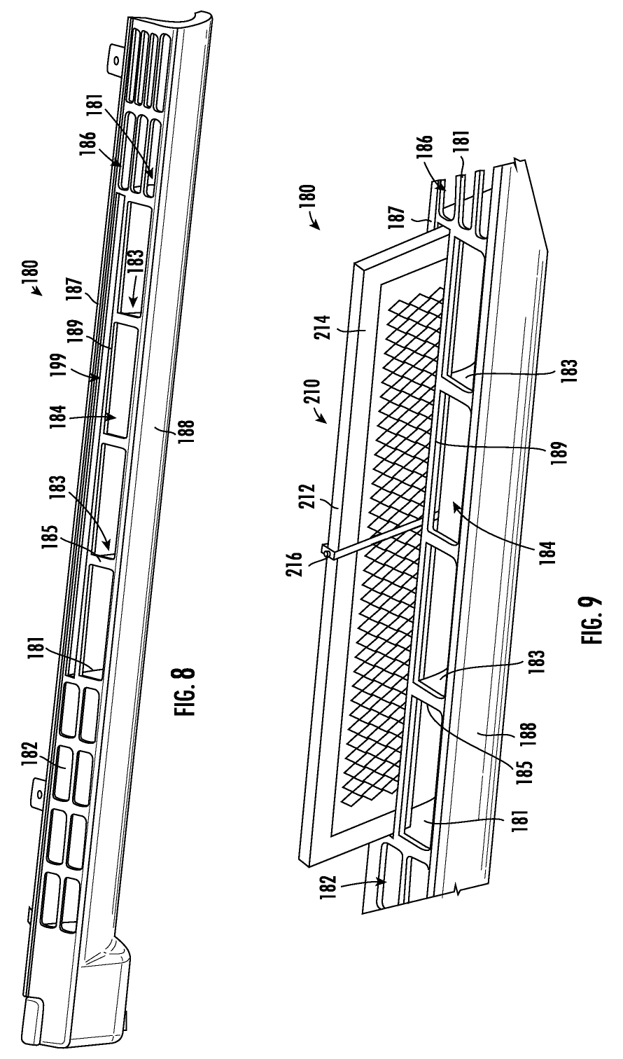

Referring to FIGS. 4-9, the deflector 180 includes a front face 188 obscuring a view one or more of cabinet openings 192, 194 from a front direction (e.g., forward viewed aft). Front face 188 may be curved or arcuate, such as to extend from the front wall 196 and outward (e.g., forward) along the transverse axis T. The front face 188 extends outward along the transverse axis T such as to extend from cabinet opening 194 along the transverse axis T. The front face 188 may urge or direct air flow from cabinet opening 194 through an airflow passage 191 formed between the front face 188 and sidewalls 181. Front face 188 may bend, curve, or include one or more faces extending from front wall 196 of cabinet 150. Front face 188 may form an open rear end 205 (e.g., rear opening) permitting flow of air from cabinet opening 192, 194 toward front face 188 and through respective deflector openings 182, 184.

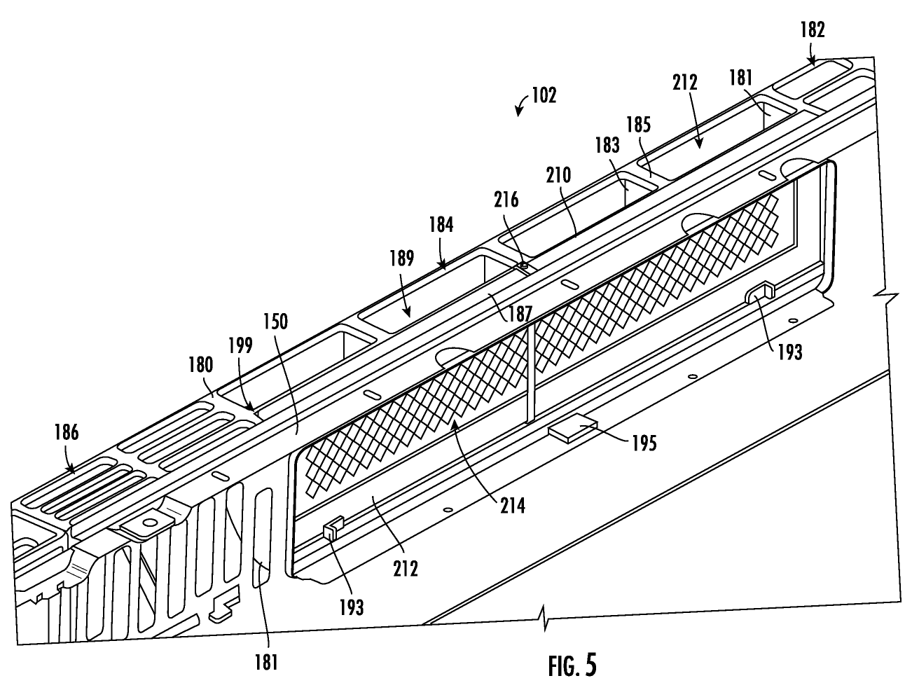

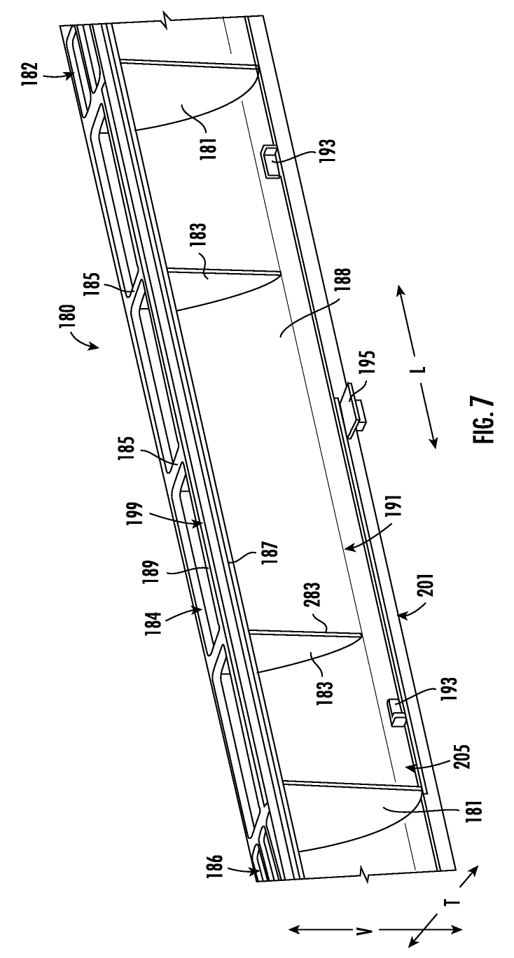

Referring to FIGS. 7-8, views of the deflector 180 in which a filter assembly 210 is removed are provided. FIGS. 5, 6, and 9 provide views of the deflector 180 in which filter assembly 210 is partially or fully provided through a filter opening 199 formed at the deflector 180. Deflector 180 includes a mount wall 183 providing a surface against which filter assembly 210 is disposable within the airflow passage 191. Mount wall 183 extends substantially along vertical direction V to provide support to a frame 212 of the filter assembly 210. Referring to FIGS. 4-9, deflector 180 includes members 187, 189 extending substantially along the lateral direction L. Filter opening 199 is formed between members 187, 189, such as forming a slit, slot, or laterally elongated opening into which filter assembly 199 is disposable.

Deflector 180 includes sidewalls 181 (e.g., a pair of sidewalls) separated from one another along the lateral direction L. Sidewalls 181 extend from front face 188 and are configured to extend to or abut the front wall 196 of the cabinet 150, such as to form airflow passage 191 between sidewalls 181 and front face 188. Sidewalls 181 may substantially fluidly segregate the flow of air through airflow passage 191 and opening 184 from outside of passage 191 (e.g., through opening 182 or opening 186).

Sidewalls 181 extends along the transverse direction T greater than mount wall 183, such that mount wall 183 leaves volume between the mount wall 183 and the front wall 196 of cabinet to dispose the filter opening 199 between the mount wall 183 and front wall 196.

Deflector 180 includes a rear face 201 configured to abut the front wall 196. In some embodiments, a tab 193 is positioned co-planar to, or proximate to, the rear face 201. Tab 193 is separated along the transverse direction T from the mount wall 183, or a rear surface 283 of the mount wall 183, such as to provide a volume between the mount wall 183 and the tab 193 at which the filter opening 199 is disposable.

In various embodiments, a rear member 187 extends substantially co-directional to rear face 201 and separated along the vertical direction V. In some embodiments, airflow passage 191 extends from rear face 201 and member 187 to opening 184. In still various embodiments, opening 184 is formed between a forward member 189 and front face 188. Opening 184 may be positioned forward along the transverse direction T from filter opening 199. One or more ribs 185 may extend from front face 188 to member 189, such as may form a plurality of openings 184. Mount wall 183 may extend along the vertical direction V from rib 185, from member 189, or both.

In still some embodiments, an attachment interface 195, such as a tab or latch, extends from the deflector 180 to attach to cabinet 150. For instance, attachment interface 195 forming a tab or latch extends from the rear face 201 of the deflector 180, such as to extend to an opening or interfacing latch at the cabinet 150.

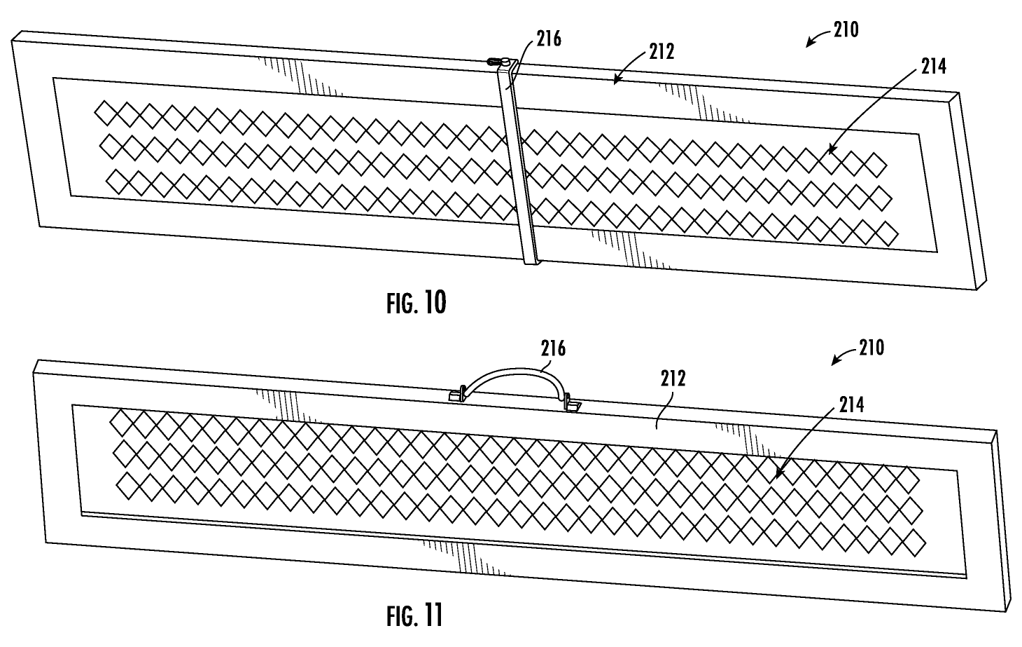

Referring briefly to FIGS. 10-12, in various embodiments, filter assembly 210 includes a frame 212 forming a body extending substantially corresponding to the volume of the airflow passage 191 between sidewalls 181, mount walls 183, and front wall 196 or tab 183. A filter 214 is positioned within frame 212. Filter 214 includes a filtering material, such as charcoal or charcoal-based substance. Filter 214 may form a mesh, web, or substate configured to retain the filtering material, such as may generally be understood. Frame 212 positions the filter 214 along the airflow passage 191 between the mount wall 183, sidewalls 181, and front wall 196 of cabinet 150.

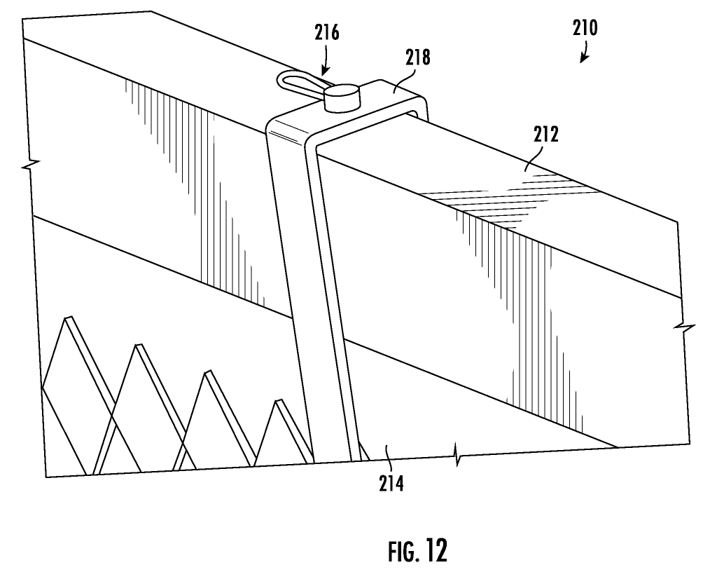

As generally depicted in FIGS. 4-12, embodiments of the deflector 180 allow a user to access the filter assembly 210 through filter opening 199 (e.g., along vertical direction V). The user may grab a handle 216 at frame 212 (FIGS. 10-12) extending through filter opening 199. The user may pull the handle 216 to translate the filter assembly 210 through filter opening 199. In some embodiments, such as depicted at FIG. 10 and 12, handle 216 may be attached to a band 218 extending around the frame 212. Band 218 may include a natural or synthetic rubber material, or rubber-coated material, or polymer material, or other appropriate material for user to pull the filter assembly 210. Band 218 may further provide a structure configured to permit rubbing and friction between the filter assembly 210 and the deflector 180 (e.g., at members 187, 189) to promote retention of the filter assembly 210 within the filter opening 199 and airflow passage 191. Band 218 may additionally, or alternatively, provide noise and vibration attenuation, such as may desirably control movement of the filter assembly 210 when air passes through the airflow passage 191.

Referring back to FIGS. 1 and 3, embodiments of the deflector 180 and microwave appliance 102 facilitate a user to access, install, and remove the filter assembly 210 without requiring removal of the deflector 180 from the cabinet 150. Easier access, installation, and removal of the filter assembly 210 may promote retention or replacement of filters, improve smoke and odor removal, and improve airflow circulation from the cabinet 150.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. An over the range microwave appliance defining a vertical direction, a lateral direction, and a transverse direction, the over the range microwave appliance comprising:
a cabinet comprising a plurality of walls forming a cooking chamber, wherein a cabinet opening is formed at a front wall of the plurality of walls;
a door positioned adjacent to the front wall when in a closed position;
a deflector comprising a front face contoured from a vent opening to a rear opening, the deflector comprising a sidewall extending from the front face to form an airflow passage extending from the vent opening to the rear opening, wherein a mount wall within the airflow passage forms a surface against which a filter assembly is disposable within the airflow passage.

2. The over the range microwave appliance of claim 1, wherein the deflector comprises a pair of sidewalls separated from one another along the lateral direction.

3. The over the range microwave appliance of claim 2, wherein the pair of sidewalls extend from the front face.

4. The over the range microwave appliance of claim 3, wherein the pair of sidewalls extends along the transverse direction toward the front wall of the cabinet to form the airflow passage between the sidewalls and the cabinet opening at the front wall.

5. The over the range microwave appliance of claim 1, wherein the sidewall fluidly segregates the airflow passage from outside of the sidewall.

6. The over the range microwave appliance of claim 1, wherein the sidewall extends along the transverse direction greater than the mount wall, wherein the mount wall forms a volume between the mount wall and the front wall of the cabinet at which the filter assembly is disposable.

7. The over the range microwave appliance of claim 6, wherein the deflector comprises a rear face configured to abut the front wall of the cabinet, and wherein a tab is positioned proximate or co-planar to the rear face, and wherein the filter assembly is disposable at the airflow passage between the mount wall and the tab.

8. The over the range microwave appliance of claim 7, wherein deflector comprises a rear member extending co-directional to the rear face, wherein the rear member and the rear face are separated along the vertical direction, and wherein the rear opening is formed between the rear face and the rear member.

9. The over the range microwave appliance of claim 8, wherein a forward member extends co-directional to the rear member, and wherein a filter opening is formed between the forward member and the rear member.

10. The over the range microwave appliance of claim 9, wherein the vent opening is positioned forward of the filter opening along the transverse direction.

11. A microwave appliance defining a vertical direction, a lateral direction, and a transverse direction, the microwave appliance comprising:
a cabinet comprising a plurality of walls forming a cooking chamber, wherein a cabinet opening is formed at a front wall of the plurality of walls;
a door positioned adjacent to the front wall when in a closed position;
a deflector comprising a front face contoured from a vent opening to a rear opening, the deflector comprising a sidewall extending from the front face to form an airflow passage extending from the vent opening to the rear opening, wherein a mount wall within the airflow passage forms a surface against which a filter assembly is disposable within the airflow passage.

12. The microwave appliance of claim 11, wherein the deflector comprises a pair of sidewalls separated from one another along the lateral direction.

13. The microwave appliance of claim 12, wherein the pair of sidewalls extend from the front face.

14. The microwave appliance of claim 12, wherein the pair of sidewalls extends along the transverse direction toward the front wall of the cabinet to form the airflow passage between the sidewalls and the cabinet opening at the front wall.

15. The microwave appliance of claim 11, wherein the sidewall fluidly segregates the airflow passage from outside of the sidewall.

16. The microwave appliance of claim 11, wherein the sidewall extends along the transverse direction greater than the mount wall, wherein the mount wall forms a volume between the mount wall and the front wall of the cabinet at which the filter assembly is disposable.

17. The microwave appliance of claim 11, wherein the deflector comprises a rear face configured to abut the front wall of the cabinet, and wherein a tab is positioned proximate or co-planar to the rear face, and wherein the filter assembly is disposable at the airflow passage between the mount wall and the tab.

18. The microwave appliance of claim 17, wherein deflector comprises a rear member extending co-directional to the rear face, wherein the rear member and the rear face are separated along the vertical direction, and wherein the rear opening is formed between the rear face and the rear member.

19. The microwave appliance of claim 18, wherein a forward member extends co-directional to the rear member, and wherein a filter opening is formed between the forward member and the rear member.

20. The microwave appliance of claim 19, wherein the vent opening is positioned forward of the filter opening along the transverse direction.
